(19) United States
(12) Patent Application Publication
(10) Pub. No.: US 2002/0104414 A1
(43) Pub. Date: Aug. 8, 2002

(54) Method and device for slicing pieces of fresh whole-muscle meat

(76) Inventors: Joachim Schill, Kehl (DE); Werner Kraus, Crailsheim (DE)

Correspondence Address: Schuster & Partner, Patentanwalte, Wiederholdstrasse 10, Stuttgart, D-70174, DE

(21) Appl. No.: 10/112,472

(22) Filed: Mar. 29, 2002

Related U.S. Application Data
(63) Continuation of application No. 09/485,521, filed on Feb. 14, 2000.

(30) Foreign Application Priority Data
Aug. 15, 1997 (DE) 197 35 597.8

(51) Int. Cl. B26D 7/00

(52) U.S. Cl. 83/19; 83/77; 83/176

(57) ABSTRACT

The invention relates to a method and device for cutting a piece of fresh whole-muscle meat into several slices having the same thickness and weight, which comprises a loading and pre-pressing unit (1) for accommodating and pressing the piece of fresh whole-muscle meat and a grading unit (2) for determining the thickness and the volume of the slices. The invention is also fitted with a slicing unit (3) arranged between the loading and pre-pressing unit (1) and the grading unit (2) to cut the piece of fresh whole-muscle meat (13) into slices (14) as determined by the grading unit (2).

This application is a continuation of Ser. No. 09/485,521 filed on Feb. 14, 2000 which, in turn, claims Paris Convention priority of DE 197 35 597 filed Aug. 15, 1997 the complete disclosure of which are hereby incorporated by reference.

### BACKGROUND OF THE INVENTION

The invention concerns a method and device for slicing pieces of fresh whole-muscle meat.

Method and devices of this type are used in canteens and for the production of assembled, packed meals. Individual slices, (in particular for quick frying, such as cutlets, steaks or filets) are cut off from a large piece of meat. It is thereby important that the individual slices of fresh whole-muscle meat have a defined thickness and weight. The slices must be apportioned as precisely as possible to ensure uniform frying or cooking time, uniform individual portions, and such that the weight can be displayed on a pre-printed packing.

Conventional cutting systems for slicing pieces of fresh whole-muscle meat cut a piece of meat into slices of equal thickness. These systems have the disadvantage that the slices of meat must be weighed after the cutting operation and the desired weight must be realized by cutting off parts by hand. This is time consuming and a large amount of inferior-quality cuttings are produced which cannot be used and which can amount to 35% of the original piece of fresh whole-muscle meat.

Precise slicing of fresh whole-muscle meat is used to produce breaded pieces of meat and for frozen products. Towards this end, the meat must be pre-frozen and shaped under very high pressure of up to 80 bar to ensure that it can subsequently be cut into appropriately thick slices in dependence on the desired weight. Disadvantageously, method and devices of this type are expensive and demanding due to the required low temperature and the high pressure. Moreover, an initial freezing of the meat is undesirable, in particular when fresh whole-muscle meat is processed, and when further preparation follows.

Methods and devices are also known in the art with which the piece of fresh whole-muscle meat is initially measured opto-electronically and the cutting lines are then determined using a computer taking into consideration the determined data and the respective specific weight of the piece of meat. Such devices are demanding and expensive. Moreover, relatively high weight tolerances have to be accepted in dependence on the accuracy of the cutting lines determined by the computer.

### SUMMARY OF THE INVENTION

In contrast thereto, the method and device according to the invention for slicing a piece of fresh whole-muscle meat according to the characterizing features of the main claim has the advantage that the weight is determined by the volume. Towards this end, the piece of meat is inserted into a loading and pre-pressing unit and pressed at a pressure of normally 3 to 4 bar. Due to its high water content and anatomical structure, fresh whole-muscle meat can be shaped at temperatures as low as —4° C. without any disadvantageous effects on its quality. The piece of meat is pressed to assume a shape having a fixed, predetermined cross-section. The loading and pre-pressing unit presses the piece of meat into the container of a grading unit which defines the thickness and the volume of the individual slices. The piece of meat is thereby pressed into a grading unit container and completely fills the container. The cross-section of the grading unit container corresponds to that of the loading and pre-pressing unit. The precisely defined cross-section and thickness precisely determine the volume and, due to the constant density of the piece of fresh whole-muscle meat, the weight of the individual slices. The individual slices must therefore not be weighed. The part of the piece of meat which is pressed into the grading unit is cut off from the remaining piece of meat using a slicing unit. This slice of meat is then ejected from the grading unit and assumes its natural shape. The slicing operation is repeated until the entire piece of fresh whole-muscle meat has been divided into slices of identical weight. The fluctuation in weight of the individual slices is very small. Only the last slice of the piece of meat is a residual cutting. The method and device according to the invention does not require freezing, measuring, shaping at very high pressures, or additional weighing or post-processing. The piece of meat can be cut, with high accuracy, into slices of equal thickness and equal weight in a rapid and simple manner without producing a large amount of unusable cuttings.

According to an advantageous embodiment of the invention, the loading and pre-pressing unit comprises a longitudinal container for receiving the piece of fresh whole-muscle meat to be sliced. One end of the container has a punch which is displaceable in the axial direction. The opposing end of the container is open. The cross-section of the container is adapted to the piece of meat to be sliced. Different containers must thereby be used e.g. for filets and roast pieces. The piece of fresh whole-muscle meat is pressed by the punch to fill the entire volume of the container. The slicing unit and the grading unit are disposed on the open end of the container.

According to another advantageous embodiment of the invention, the container comprises an opening on a side extending in the longitudinal direction, which can be closed by means of a lid. The piece of meat to be sliced can thereby be inserted into the container in a convenient manner.

According to another advantageous embodiment of the invention, the grading unit is disposed on the end of the loading and pre-pressing unit facing away from the punch. The grading unit comprises a container which is open on one side, wherein the shape and size of the open side coincide with the open end of the loading and pre-pressing unit container. Moreover, the cross-section of the container is similar to that of the loading and pre-pressing unit container and its depth matches the predetermined thickness of the slices. The container may assume two positions. In a first position, it is disposed as an extension of the loading and pre-pressing unit container and its open side faces the open side of that container. In a second position, the grading unit container, or parts thereof, is/are pivoted away or displaced from the loading and pre-pressing unit such that its open side faces downwardly. The container can be transferred from the first to the second position and vice versa via a pivoting or displacement device. In the first position (as an extension of the loading and pre-pressing unit container), the piece of fresh whole-muscle meat to be sliced is pressed into the grading unit container. After the slice is cut off from the piece of meat, the container is transferred to its second position in which the slice is ejected and transported away.

According to a further advantageous embodiment of the invention, the grading unit container forms a fixed unit and can be pivoted away, as a whole, from the loading and pre-pressing unit. If the loading and prepressing unit is arranged horizontally, the fixed container has to be pivoted such that the open side of the container faces downwardly to enable transport of the cut-off slices.

According to a further advantageous embodiment of the invention, the grading unit container comprises a grading plate having an opening, and a base plate disposed on the grading plate. The cross-section of the opening coincides with the cross-section of the loading and pre-pressing unit. The thickness of the grading plate corresponds with the predetermined thickness of the slices. The grading plate can be displaced between the slicing unit and the base plate. Should the loading and pre-pressing unit be arranged vertically, the grading unit may be disposed at the end facing downwards. The opening of the grading plate is disposed as an extension of the loading and pre-pressing unit for pressing the piece of fresh whole-muscle meat into the grading unit container. The piece of meat is pressed by the punch against the base plate closing the grading unit container. After cutting the slice with the slicing element, the grading plate containing the piece of meat is displaced between the stationary slicing element and the stationary base plate in such a manner that the grading plate opening can be accessed from below. The slice drops downwardly through the opening under the force of gravity. This may be supported by a punch projecting into the opening from the top.

According to a further advantageous embodiment of the invention, the slicing device comprises a slicing element disposed, at a first position, between the loading and pre-pressing unit container and the grading unit container and completely closes the loading and pre-pressing unit container at this side. In a second position, the slicing element completely opens the end of the loading and pre-pressing unit container and allows displacement of the piece of fresh whole-muscle meat into the grading unit container. During transfer from the second to the first position, that part of the piece of fresh whole-muscle meat which is pressed into the grading unit is cut off from the remaining piece of meat. Since the loading and pre-pressing unit container is completely closed in its first position by the slicing element, the piece of meat can already be pressed by the punch during transport of the slice by the grading unit. It is once more pressed into the grading unit container during transfer of the slicing element into its second position. This operation is repeated until the entire piece of fresh whole-muscle meat has been cut into individual slices.

According to a further advantageous embodiment of the invention, the piece of fresh whole-muscle meat in the loading and pre-pressing unit container can be pressed with a pressure of between 3 and 4 bar. Pressures of this type are sufficient to shape the piece of meat in a reliable manner such that it completely fills the predetermined volume with no cavities being formed.

According to a further advantageous embodiment of the invention, the slicing element is a knife with a blade that extends obliquely with respect to the direction of motion of the slicing element. A knife of this type functions like a guillotine to cut the slice from the piece of fresh whole-muscle meat to thereby effect a slicing cut. Knives of this type are more advantageous than knives having sawing motion, since the meat must not follow such periodic sawing motion, and dead points do not occur during cutting.

According to a further advantageous embodiment of the invention, the slicing element is a knife with a crescent-shaped blade, wherein the knife is arranged to pivot or rotate about an axis.

According to a further advantageous embodiment of the invention, several slicing elements are disposed on the slicing unit, parallel to one another in the axial direction. The distance between two slicing elements therefore corresponds to the predetermined thickness of the slices, in each case. In this manner, several slices can be cut off the piece of fresh whole-muscle meat at the same time to accelerate the slicing process. Several loading and pre-pressing units and several grading units can also be disposed next to one another. In this case, the common slicing element cuts several slices off various pieces of meat simultaneously during one cutting operation.

According to a further advantageous embodiment of the invention, the side opposite the open side of the grading unit container has holes to which pressure lines are connected, external to the container. In this manner, an under-pressure can be generated inside the grading unit container to assure that the piece of fresh whole-muscle meat completely fills the container volume. During transport of the cut-off slice, the slice is initially kept in the grading unit container by this under-pressure until the container has reached its final position above the transport unit. As soon as the container has reached this final position, an over-pressure is generated in the container via the pressure line. This over-pressure supports ejection of the slice from the container and prevents pieces of fresh whole-muscle meat from remaining in the holes.

According to a further advantageous embodiment of the invention, punches are disposed in a displaceable manner on the grading unit outside of the container and can be displaced into the container when the container, or parts of the container, are in the second position. These punches provide additional support for ejection of the cut-off slice from the grading unit container. The punches may e.g. project through the holes into the grading unit container. In this case, the pieces of fresh whole-muscle meat remaining in the holes are cleared away by the punches. It is, however, also possible for the punches to project through the opening in the grading plate.

According to a further advantageous embodiment of the invention, the depth of the grading unit container can be adjusted. In this manner, the predetermined thickness and weight of the slice may be varied.

A further advantageous embodiment of the invention provides a transport means on which the slices can be disposed via the grading unit. The transport means, e.g. a conveyor belt, may advance the cut slices for further processing.

Further advantages and advantageous embodiments of the invention can be extracted from the following description, the drawing and the claims.

Embodiments of the invention are shown in the drawing and explained in more detail below.

### BRIEF DESCRIPTION OF THE DRAWING

FIG. 1 illustrates a side view of the method and device according to the invention;

FIG. 2 illustrates part of the method and device of FIG. 1, wherein the grading unit container is disposed in extension of the loading and pre-pressing unit;

FIG. 3 illustrates the method and device of FIG. 1, wherein the grading unit container is located in a downwardly pivoted position;

FIG. 4 shows a slicing unit and a loading and pre-pressing unit, viewed in the axial direction;

FIG. 5 shows a grading unit container, viewed in the axial direction;

FIG. 6 illustrates a side view of a further embodiment of a method and device according to the invention;

FIG. 7 illustrates the method and device of FIG. 6 after cutting off the piece of meat.

### DESCRIPTION OF THE PREFERRED EMBODIMENT

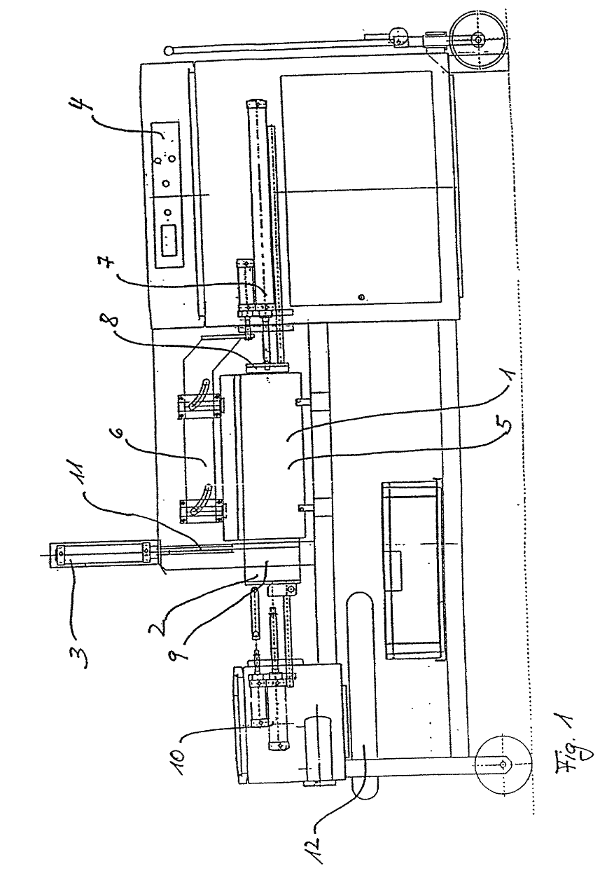

FIG. 1 illustrates, in side view, the method and device according to the invention for slicing a piece of meat. The device consists essentially of a loading and pre-pressing unit 1, a grading unit 2 and a slicing unit 3. The parameters and functions of the method and device can be defined by an operating means 4. The loading and pre-pressing unit 1 comprises a container 5, a lid 6 closing the container from the top and a presser 8 actuated by a cylinder 7. The presser 8 closes the container 5 at its right end and is displaced in the axial direction for pressing the inserted piece of fresh whole-muscle meat. The grading unit 2 consists essentially of a container 9 and a tilting and pivoting cylinder 10 for pivoting the container. Pressure lines are also connected to the container 9 (not shown in FIG. 1). The slicing unit 3 comprises a slicing element 11 to cut off the slice from the piece of fresh whole-muscle meat. The cut pieces of meat are advanced for further processing via a transport line 12.

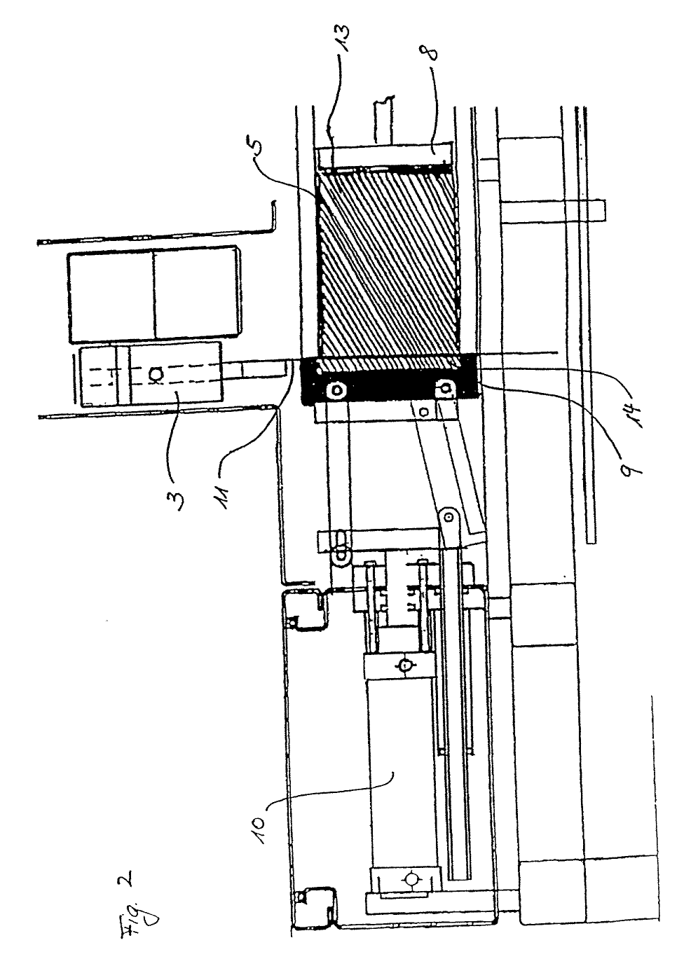

FIG. 2 shows a simplified representation of a section of the device of FIG. 1. A piece of fresh whole-muscle meat 13 (drawn with cross-hatches) is inserted into the container 5 of the loading and pre-pressing unit 1 and is pressed against the cutting element 11 via the presser 8. The slicing element 11 has just cut the slice 14, pressed into the container 9 of the grading unit 2.

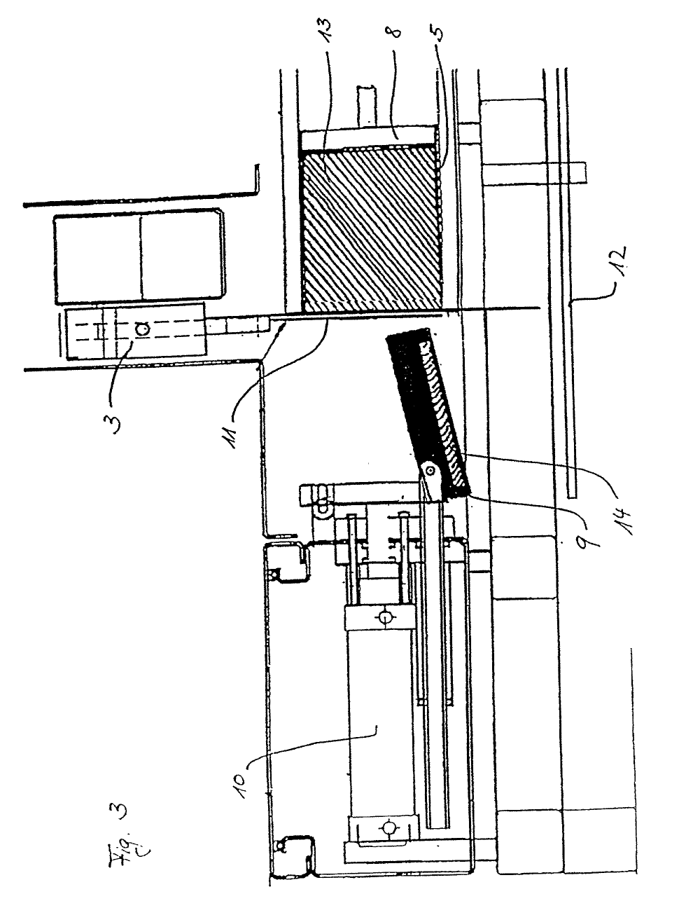

As shown in FIG. 3, the container 9 of the grading unit 2 is then pivoted downwardly by the loading and pre-pressing unit 1 such that the open side of the container faces in a downward direction. Finally, the piece of fresh whole-muscle meat is ejected from the container 9 of the grading unit 2 and deposited onto a transport line 12.

FIG. 4 shows an axial view of the slicing unit and the loading and pre-pressing unit container. The lower, inward portion of the container 5 of the loading and pre-pressing unit 1 is rounded. The lid 6 closing the container 5 from the top is also rounded at the side facing the piece of fresh whole-muscle meat. The piece of meat is thereby pressed into a shape of oval cross-section. The slicing element 11 of the slicing unit 3 is shaped like a guillotine, with an obliquely extending cutting edge 15. For cutting off the slice from the piece of fresh whole-muscle meat, the slicing element 11 is lowered from the top to the bottom and thereby executes a slicing cut. In its final bottom position, the slicing element 11 completely covers the oval opening on the front end of the container.

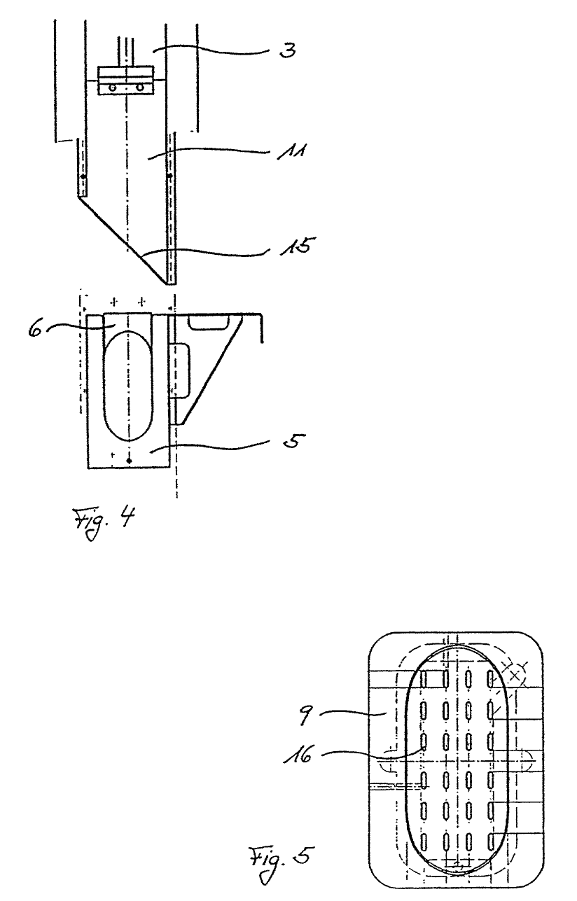

FIG. 5 shows that part of the grading unit 2 which faces the loading and pre-pressing unit 1. The inwardly facing part of the container 9 has the same oval cross-section as the inner volume of the container 5 of the loading and pre-pressing unit 1 (see FIG. 4). The side of the container facing away from the loading and pre-pressing unit has a plurality of oval holes 16 through which punches (not shown in the drawing) can project to help eject the cut slice of fresh whole-muscle meat from the container. In addition, pressure lines (not shown) may be connected to these holes on the side facing away from the slice of meat for generating an under-pressure or an over-pressure in the container. The under-pressure draws in the slice of meat to fill the entire inner volume of the container. The over-pressure supports ejection of the slice of fresh whole-muscle meat from the container.

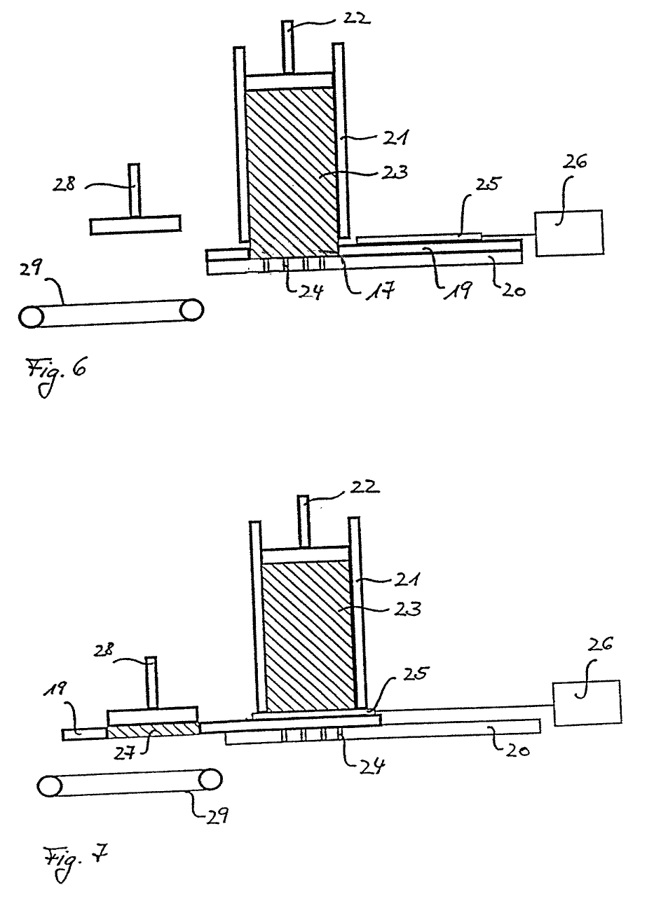

FIGS. 6 and 7 show a further embodiment of a device for carrying out the method according to the invention. The grading unit container comprises a grading plate 19 provided with an opening 17 and a base plate 20. The loading and pre-pressing unit container 21 extends in a vertical direction above the grading unit. The opening 17 has the same cross-section as that of the loading and pre-pressing unit container. The presser 22 presses the piece of fresh whole-muscle meat 23 downwardly into the grading unit opening 17. The base plate comprises holes 24 to which pressure lines are connected (not shown in the drawing). An under-pressure is thereby generated in the opening 17 such that the piece of fresh whole-muscle meat 23 completely fills the opening 17. When the piece of meat has been pressed into the opening 17, the slicing element 25 is moved by the cylinder 26 from the position shown in FIG. 6 into the position shown in FIG. 7 to thereby cut off the slice in the grading unit opening 17 from the piece of meat 23. The grading plate 19 is then displaced to the side and the slice of fresh whole-muscle meat 27 is pressed out of the opening 18 in the grading plate using a presser 28. The piece of meat drops downwardly and is advanced on a transport line 29 for further processing.

A plurality of the devices shown in FIGS. 6 and 7 may be arranged next to one another. In this case, only one cylinder is needed for moving the various slicing elements. Several pieces of fresh whole-muscle meat can be simultaneously cut using such a device.

All the features shown in the description, in the following claims and in the drawing may be essential to the invention either individually or collectively in arbitrary combination:

We claim:

1. A method for slicing a piece of fresh whole-muscle meat into slices of substantially equal thickness and weight, the method comprising the steps of:
a) inserting the piece of fresh whole-muscle meat into a loading and pre-pressing unit;
b) exerting a pressing force an a first side of the fresh whole-muscle meat to urge a second side of the meat into a grading unit, said grading unit communicating with said loading and pre-pressing unit to define a thickness and a volume of the slices;
c) cutting off a slice from the piece of meat using a slicing unit disposed between said loading and pre-pressing unit and said grading unit; and
d) moving said grading unit in one of a pivoting and displacing manner to remove the slice of fresh whole-muscle meat.

2. The method of claim 1, wherein said loading and pre-pressing unit comprises a longitudinal container for receiving the piece of meat, and a presser, at an end of said container, which is displaceable in an axial direction, wherein said container is open at an end opposite said presser proximate said grading unit.

3. The method of claim 2, wherein said container has an opening on a longitudinal side thereof, said container comprising a lid removably disposed over said opening for closing said opening.

4. The method of claim 2, wherein step b) comprises the step of controlling said loading and pre-pressing unit to drive said presser for exerting said pressing force on the meat, said pressing force generating a pressure of between 3 and 4 bar on the piece of fresh whole-muscle meat.

5. The method of claim 1, further comprising the step of cooling, immediately prior to step a), said piece of meat to a temperature greater than or equal to −4° C.

6. A device for slicing a piece of fresh whole-muscle meat into slices of substantially equal thickness and weight using the method of claim 1, the device comprising:
means for loading the piece of fresh whole-muscle into a loading and pre-pressing unit;
means for exerting a pressing force an a first side of the fresh whole-muscle meat to urge a second side of the meat into a grading unit, said grading unit communicating with said loading and pre-pressing unit to define a thickness and a volume of the slices;
means for cutting off a slice from the piece of meat using a slicing unit disposed between said loading and pre-pressing unit and said grading unit; and
means for moving said grading unit in one of a pivoting and displacing manner to remove the slice of fresh whole-muscle meat.

7. The device of claim 6, wherein said loading and pre-pressing unit comprises a longitudinal container for receiving the piece of meat, and a presser, at an end of said container, which is displaceable in an axial direction, wherein said container is open at an end opposite said presser proximate said grading unit.

8. The device of claim 7, wherein said container has an opening on a longitudinal side thereof, said container comprising a lid removably disposed over said opening for closing said opening.

9. The device of claim 7, wherein said pressing force exerting means comprises means for controlling said loading and pre-pressing unit to drive said presser for exerting said pressing force on the meat, wherein said pressing force generates a pressure of between 3 and 4 bar on the piece of meat.

10. The device of claim 6, further comprising means for cooling and said piece of meat to a temperature greater than or equal to −4° C., immediately prior to pressing the meat.
